(19) United States
(12) Patent Application Publication
(10) Pub. No.: US 2009/0189916 A1
(43) Pub. Date: Jul. 30, 2009

(54) IMAGE WARPING METHOD

(76) Inventor: Chou-Liang TSAI, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/020,238

(22) Filed: Jan. 25, 2008

(51) Int. Cl. G09G 5/00

(52) U.S. Cl. 345/647

(57) ABSTRACT

An image warping method is disclosed, and comprises: providing a source polygon; providing a warping relationship; dividing the source polygon into a plurality of source triangles; sequentially performing a warping step on the source triangles one by one to generate a plurality of warped triangles; and combining the warped triangles to generate a warped polygon.

### FIELD OF THE INVENTION

This invention relates to an image warping method, and more particularly, to techniques for using interpolation to warp an image.

### BACKGROUND OF THE INVENTION

Electronic images are often manipulated to produce variant forms of images. For example, many existing off-the-shelf software image viewers and editors allow an image to be manipulated within a display for purposes of obtaining different perspective views of the image. Some viewing functions include zooming in on different locations within the image, panning out on different locations within the image, scaling the image by spatially reallocating the content of the image, rotating the image, and the like. Of course, image manipulation is also useful when printing images, mining the images for information, correcting distortions or creating distortions within the images, integrating the images into other software applications, image morphing and the like. Said image manipulation is often referred to as image warping. Image warping has been evolving for decades, and has grown to embrace a wide variety of applications, such as medical imaging, computer graphics, and computer vision. As computers become more powerful, image warping has become well suited to enhance such fields as special effects and image synthesis. Therefore, the present invention presents a new image warping method.

### SUMMARY OF THE INVENTION

Therefore, an aspect of the present invention is to provide an image warping method to warp a source image to a warped image.

According to an embodiment of the present invention, the image warping method comprises: providing a source polygon; providing a warping relationship; dividing the source polygon into a plurality of source triangles; sequentially performing a warping step on the source triangles one by one to generate a plurality of warped triangles; and combining the warped triangles to generate a warped polygon, wherein each of the source triangles is composed of a plurality of first pixel units and comprises a plurality of first vertices, the warped triangle is composed of a plurality of second pixel units and comprises a plurality of second vertices.

According to another embodiment of the present invention, the warping step comprises: calculating a plurality of second vertices of the warped triangle in accordance with the warping relationship and the first vertices; and performing an interpolation step in accordance with the second vertices and the warping relationship to generate the warped triangle.

According to still another embodiment of the present invention, the warped triangle is composed of a plurality of second pixel units, and the interpolation step further comprises accumulating a first distance between every two adjacent second pixel units to generate a first address of each of the second pixel units.

According to further another embodiment of the present invention, the interpolation step comprises generating a second distance between two first pixel units of the source polygon in accordance with the first distance, wherein the two first pixel units are associated with the two adjacent second pixel units.

According to further another embodiment of the present invention, the interpolation step comprises accumulating the second distance to generate a plurality of source addresses of the first pixel units.

According to further another embodiment of the present invention, the interpolation step comprises accumulating the second distance to generate a plurality of source addresses of the first pixel units.

According to further another embodiment of the present invention, the interpolation step is linear interpolation.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart showing an image warping method according to a first embodiment of the present invention;

FIG. 2 is a flow chart showing the warping step according to a second embodiment of the present invention;

FIG. 3 is a flow chart showing the interpolation step according to a third embodiment of the present invention; and

FIG. 4 is a diagram showing the source triangle and the warped triangle according to the third embodiment of the present invention.

### DETAILED DESCRIPTION OF THE PREFERRED EMBODIMENT

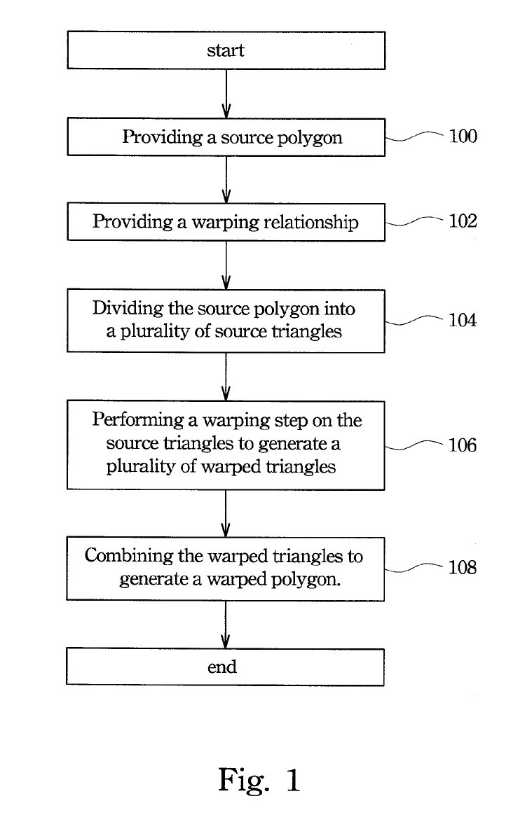

In order to make the illustration of the present invention more explicit and complete, the following description is stated with reference to FIG. 1 through FIG. 26.

Referring to FIG. 1. FIG. 1 is a flow chart showing an image warping method according to a first embodiment of the present invention. In step 100, a source polygon is provided. In the first embodiment, the source polygon may be data stored in an electrical device. In step 102, a warping relationship is provided, wherein the warping relationship is the difference between the source polygon and a warped polygon. Users can determine the shape of the warped polygon by determining the warping relationship. In step 104, the source polygon is divided into a plurality of source triangles, wherein each of the source triangles comprises three vertices. In step 106, a warping step is sequentially performed on the source triangles to generate a plurality of warped triangles. In step 108, the warped triangles are combined to generate the warped polygon.

In view of the above description, the image warping method in accordance with this embodiment can decrease the cost of CPU resource via dividing the source polygon into the source triangles and sequentially performing the warping step on the source triangles.

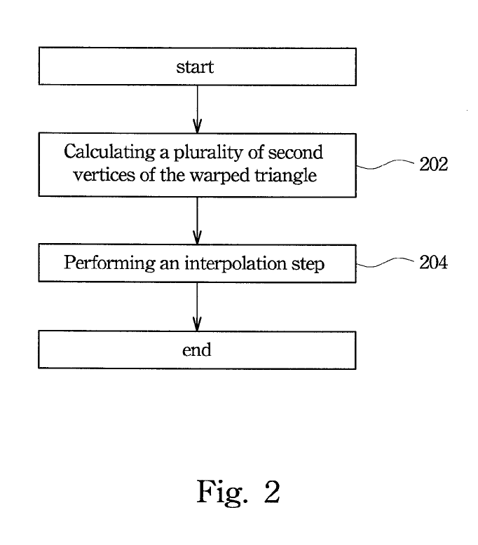

Referring to FIG. 2. FIG. 2 is a flow chart showing the warping step according to a second embodiment of the present invention, wherein the warping step comprises steps 202 and 204. In step 202, three vertices of the warped triangle are calculated in accordance with the warping relationship and the first vertices. The warping relationship may be a matrix expressing the mathematic relationship between the source polygon and the warped polygon, thus that the second vertices can be calculated via the matrix. In step 204, an interpolation step is performed in accordance with the second vertices and the warping relationship to generate the warped triangle. In the second embodiment, the interpolation algorithm used in the interpolation step is linear interpolation, but the scope of the interpolation algorithm is not limited herein. In the other embodiment of the present invention, the interpolation algorithm may be a polynomial interpolation, spline interpolation, nearest neighbor interpolation . . . etc.

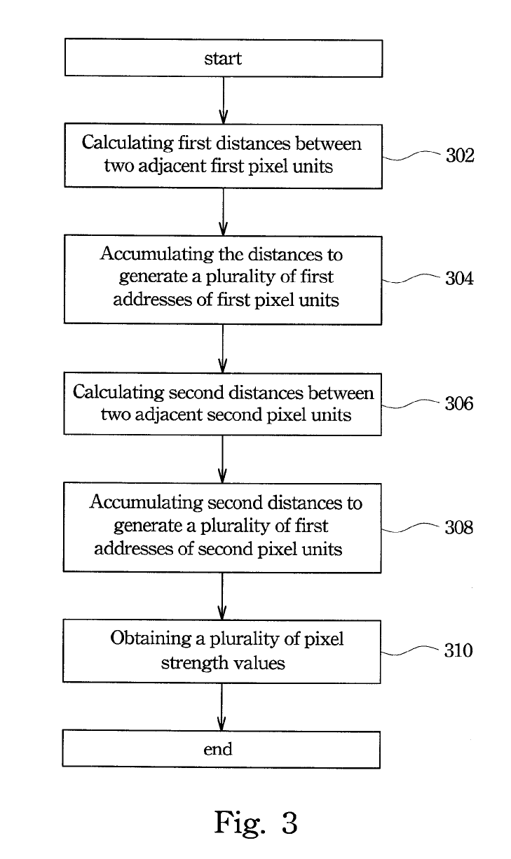

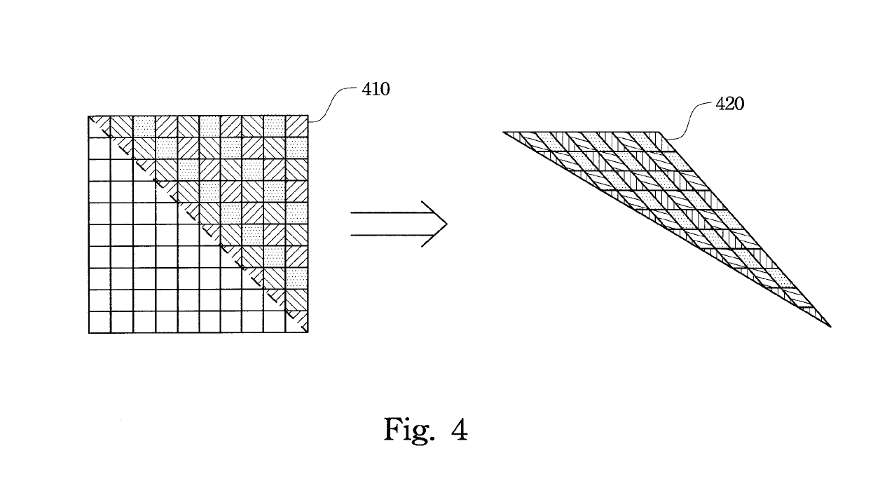

Referring to FIG. 3 and FIG. 4. FIG. 3 is a flow chart showing the interpolation step according to a third embodiment of the present invention, FIG. 4 is a diagram showing the source triangle and the warped triangle according to the third embodiment of the present invention, wherein the interpolation step comprises steps 302, 304, 306, 308 and 310. The warped triangle is composed of a plurality of first pixel units and the source triangle is composed of a plurality of second pixel units. In the step 302, distances Dx and Dy are calculated, wherein the distance Dx presents the horizontal distance between two adjacent first pixel units, and the distance Dy presents the vertical distance between two adjacent first pixel units. In step 304, the distance Dx and Dy are accumulated to generate a plurality of first addresses of the first pixel units. In the third embodiment, the accumulating sequence is that accumulating the distances Dx in the first pixel row from left to right, and then adding the distance Dy once to accumulate the distances Dx in the second pixel row, and so forth. In step 306, distances Du and Dv are calculated via an interpolation algorithm, wherein the distance Du presents the horizontal distance between two adjacent second pixel units, and the distance Dv presents the vertical distance between two adjacent second pixel units. In step 308, the distances Du and Dv are accumulated to generate a plurality of second addresses of the second pixel units corresponding to the first addresses. In step 310, obtaining a plurality of pixel strength values of the first pixel units in accordance with the second addresses, wherein the pixel strength value presents the gray level or the lightness of the pixel units.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. An image warping method, comprising:
providing a source polygon;
providing a warping relationship;
dividing the source polygon into a plurality of source triangles, wherein each of the source triangles is composed of a plurality of first pixel units and comprises a plurality of first vertices;
sequentially performing a warping step on the source triangles one by one to generate a plurality of warped triangles; and
combining the warped triangles to generate a warped polygon.

2. The image warping method as claimed in claim 1, wherein the warping step comprises:
calculating a plurality of second vertices of the warped triangle in accordance with the warping relationship and the first vertices; and
performing an interpolation step in accordance with the second vertices and the warping relationship to generate the warped triangle.

3. The image warping method as claimed in claim 2, wherein the warped triangle is composed of a plurality of second pixel units, and the interpolation step further comprises accumulating a first distance between every two adjacent second pixel units to generate a first address of each of the second pixel units.

4. The image warping method as claimed in claim 3, wherein the interpolation step comprises generating a second distance between two first pixel units of the source polygon in accordance with the first distance, wherein the two first pixel units are associated with the two adjacent second pixel units.

5. The image warping method as claimed in claim 4, wherein the interpolation step comprises accumulating the second distance to generate a plurality of source addresses of the first pixel units.

6. The image warping method as claimed in claim 1, wherein the interpolation step is linear interpolation.
